(19) United States
(12) Patent Application Publication
(10) Pub. No.: US 2023/0014206 A1
(43) Pub. Date: Jan. 19, 2023

(54) FUEL CELL AND METHOD OF MANUFACTURING THE SAME

(71) Applicants: HYUNDAI MOTOR COMPANY, Seoul (KR); KIA CORPORATION, Seoul (KR)

(72) Inventor: Dae Han Ka, Yongin-si (KR)

(73) Assignees: Hyundai Motor Company, Seoul (KR); KIA CORPORATION, Seoul (KR)

(21) Appl. No.: 17/847,558

(22) Filed: Jun. 23, 2022

(30) Foreign Application Priority Data
Jul. 14, 2021 (KR) 10-2021-0092113

(51) Int. Cl. H01M 8/04007; H01M 8/248; H01M 8/241; H01M 8/04082; H01M 8/04089; H01M 8/04701

(52) U.S. Cl. CPC H01M 8/04037; H01M 8/248; H01M 8/241; H01M 8/04201; H01M 8/04089; H01M 8/04701; H01M 2008/1095

(57) ABSTRACT

A fuel cell includes a cell stack including a plurality of unit cells stacked in a first direction, end plates respectively disposed at first and second end portions of the cell stack, each of the end plates including a core having first rigidity and a clad covering at least a portion of the core, the clad having second rigidity which is lower than the first rigidity, a heater plate provided with a heating element configured to generate heat in response to a driving power supply, the heater plate being disposed at at least one of positions between the end plates and the first and second end portions of the cell stack, and a connector accommodated in the core of each of the end plates and covered by the clad, the connector interconnecting the driving power supply and the heating element.

### CROSS-REFERENCE TO RELATED APPLICATION

The present application claims priority to Korean Patent Application No. 10-2021-0092113, filed on Jul. 14, 2021, the entire contents of which is incorporated herein for all purposes by this reference.

### BACKGROUND OF THE PRESENT INVENTION

### Field of the Invention

The present invention relates to a fuel cell and a method of manufacturing the same.

### Description of Related Art

In general, a fuel cell includes a cell stack and a heater assembly. In winter, water freezes inside an end cell of the cell stack due to the low outdoor air temperature, and thus electricity is not generated in the end cell, deteriorating the initial startability and power generation efficiency of the fuel cell. To solve the present problem, the heater assembly serves to heat the end cell during initial startup. To this end, the fuel cell requires a connector for supplying driving voltage to the heater assembly. However, the thickness of a bypass plate accommodating the connector is thus increased, and the flatness and surface roughness of the bypass plate accommodating the connector are deteriorated. Therefore, various research with the goal of solving the present problem is underway.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a fuel cell and a method of manufacturing the same that substantially obviate one or more problems due to limitations and disadvantages of the related art.

Embodiments provide a fuel cell which is lightweight and thin and has excellent durability and airtightness and a method of manufacturing the same.

However, objects to be accomplished by the exemplary embodiments are not limited to the above-mentioned objects, and other objects not mentioned herein will be clearly understood by those skilled in the art from the following description.

A fuel cell according to various exemplary embodiments of the present invention may include a cell stack including a plurality of unit cells stacked in a first direction, end plates respectively disposed at first and second end portions of the cell stack, each of the end plates including a core having first rigidity and a clad covering at least a portion of the core, the clad having second rigidity which is lower than the first rigidity, a heater plate provided with a heating element configured to generate heat in response to a driving power supply, the heater plate being disposed at at least one of positions between the end plates and the first and second end portions of the cell stack, and a connector accommodated in the core of each of the end plates and covered by the clad, the connector interconnecting the driving power supply and the heating element.

For example, the end plates may include at least one of a first end plate disposed at one of the first and second end portions of the cell stack or a second end plate disposed at the remaining one of the first and second end portions of the cell stack, the core may include at least one of a first core of the first end plate or a second core of the second end plate, the clad may include at least one of a first clad of the first end plate or a second clad of the second end plate, the heater plate may include at least one of a first heater plate disposed between the one of the first and second end portions of the cell stack and the first end plate or a second heater plate disposed between the remaining one of the first and second end portions of the cell stack and the second end plate, the heating element may include at least one of a first heating element mounted to the first heater plate or a second heating element mounted to the second heater plate, and the connector may include at least one of a first connector accommodated in the first end plate to interconnect the first heating element and the driving power source or a second connector accommodated in the second end plate to interconnect the second heating element and the driving power supply.

For example, the first end plate and the first heater plate may be modularized, and the second end plate and the second heater plate may be modularized.

For example, each of the first heater plate and the second heater plate may be composed of one bypass plate.

For example, each of the first connector and the second connector may include a power connection portion having a positive terminal and a negative terminal connected to the driving power supply, a first internal wire having one end portion connected to the positive terminal of the power connection portion, a second internal wire having one end portion connected to the negative terminal of the power connection portion, a first terminal portion connected to the opposite end portion of the first internal wire, and a second terminal portion connected to the opposite end portion of the second internal wire.

For example, at least one of the first internal wire or the second internal wire may have a flat shape without a stepped portion.

For example, the first internal wire and the second internal wire of the first connector may be accommodated in the first core and may be covered by the first clad, and the first internal wire and the second internal wire of the second connector may be accommodated in the second core and may be covered by the second clad.

For example, the first core may include a first internal surface facing the one of the first and second end portions of the cell stack in the first direction, the first internal surface having a first groove formed therein to be concavely depressed to allow the first internal wire and the second internal wire to be received therein, and a first external surface formed opposite to the first internal surface. The second core may include a second internal surface facing the remaining one of the first and second end portions of the cell stack in the first direction, the second internal surface having a second groove formed therein to be concavely depressed to allow the first internal wire and the second internal wire to be received therein, and a second external surface formed opposite to the second internal surface.

For example, the first internal wire and the second internal wire of the first connector may be enveloped by a third clad and may be received in the first groove, and the first internal wire and the second internal wire of the second connector may be enveloped by a fourth clad and may be received in the second groove.

For example, the third clad may include a first fixing portion, protruding from a region between the power connection portion and the first terminal portion in a direction intersecting the direction in which the power connection portion and the first terminal portion face each other to fix the first connector to the first core, and a second fixing portion, protruding from a region between the power connection portion and the second terminal portion in a direction intersecting the direction in which the power connection portion and the second terminal portion face each other to fix the first connector to the first core.

For example, the first core may include a first concave portion receiving the first fixing portion therein and a second concave portion receiving the second fixing portion therein.

For example, at least one of the first end plate or the second end plate may include a hydrogen inlet introducing hydrogen as a reactant gas from the outside thereof into the cell stack, an oxygen inlet introducing oxygen as a reactant gas from the outside thereof into the cell stack, a hydrogen outlet discharging hydrogen as a reactant gas and condensate water from the cell stack to the outside, an oxygen outlet discharging oxygen as a reactant gas and condensate water from the cell stack to the outside, a coolant inlet introducing a cooling medium from the outside thereof into the cell stack, and a coolant outlet discharging a cooling medium to the outside.

For example, each of the first concave portion, the second concave portion, the first groove, and the second groove may be formed in a region other than the regions in which the hydrogen inlet, the oxygen inlet, the hydrogen outlet, the oxygen outlet, the coolant inlet, and the coolant outlet are disposed.

For example, the first end plate may include the hydrogen inlet, the oxygen inlet, the hydrogen outlet, and the oxygen outlet. The second end plate may include the coolant inlet and the coolant outlet. The first concave portion, the second concave portion, and the first groove may be spaced from the hydrogen inlet, the oxygen inlet, the hydrogen outlet, and the oxygen outlet. The second groove may be spaced from the coolant inlet and the coolant outlet.

For example, the first heater plate may include a first central area in which the first heating element is disposed and a first peripheral area formed adjacent to the first central area. The second heater plate may include a second central area in which the second heating element is disposed and a second peripheral area formed adjacent to the second central area. At least one of the first peripheral area or the second peripheral area may have a flat shape.

A method of manufacturing a fuel cell according to another exemplary embodiment of the present invention may include forming a groove in a core of at least one of end plates to be disposed at respective end portions of a cell stack, the core having first rigidity, mounting a connector in the groove, applying a clad having second rigidity to at least a portion of the core to cover the connector, the second rigidity being lower than the first rigidity, coupling a heater plate to each of the end plates to which the clad has been applied, and inserting a heating element into the heater plate while connecting the heating element to the connector.

For example, the method of manufacturing the fuel cell may further include enveloping the connector using another clad provided separately from the above clad. The connector enveloped by the other clad may be mounted in the groove.

For example, the core may include a metal material, and the clad may include resin.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The accompanying drawings, which are included to provide a further understanding of the present invention and are incorporated in and form a part of the present application, illustrate embodiment(s) of the present invention and together with the description serve to explain the principle of the present invention. In the drawings:

FIG. 1 is a perspective view showing the external appearance of a fuel cell according to various exemplary embodiments of the present invention;

FIG. 2 is a cross-sectional view of an exemplary embodiment for explaining end plates, a cell stack, and heater assemblies included in the fuel cell according to the embodiment;

FIG. 3A is an exploded perspective view of an exemplary embodiment of a first heater assembly;

FIG. 3B is a view showing the disassembled state of a first heating element and a first end plate accommodating a first connector;

FIG. 4A and FIG. 4B are rear views of a first connector;

FIG. 5 is a cross-sectional view of the exemplary embodiment of the first heater assembly;

FIG. 6A is an exploded perspective view of an exemplary embodiment of a second heater assembly;

FIG. 6B is a view showing the disassembled state of a second heating element and a second end plate accommodating a second connector;

FIG. 7A, FIG. 7B, FIG. 7C, and FIG. 7D are views showing an exemplary embodiment of a second connector;

FIG. 8 is a cross-sectional view of the exemplary embodiment of the second heater assembly;

FIG. 9A, FIG. 9B, FIG. 9C, FIG. 9D, FIG. 9E, FIG. 9F and FIG. 9G are views for explaining a method of manufacturing the first heater assembly of the fuel cell;

FIG. 10A, FIG. 10B, FIG. 10C, FIG. 10D, FIG. 10E, FIG. 10F, FIG. 10G and FIG. 10H are views for explaining a method of manufacturing the second heater assembly of the fuel cell;

FIG. 11 is an exemplary cross-sectional view of the first or second connector in the fuel cell according to the embodiment; and

FIG. 12 is a cross-sectional view of a first or second connector in a fuel cell according to a comparative example.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

The present invention will now be described more fully hereinafter with reference to the accompanying drawings, in which various embodiments are shown. The examples, however, may be embodied in various forms and should not be construed as being limited to the exemplary embodiments set forth herein. Rather, these embodiments are provided so that the present disclosure will be more thorough and complete, and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

Furthermore, relational terms, such as “first”, “second”, “on/upper part/above” and “under/lower part/below”, are used only to distinguish between one subject or element and another subject or element, without necessarily requiring or involving any physical or logical relationship or sequence between the subjects or elements.

Hereinafter, a fuel cell 100 according to an exemplary embodiment will be described with reference to the accompanying drawings. The fuel cell 100 will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the exemplary embodiments are not limited thereto. That is, the x-axis, the y-axis, and the z-axis may intersect each other obliquely. Hereinafter, for convenience of description, the +x-axis direction or the −x-axis direction will be referred to as a “first direction”, the +y-axis direction or the −y-axis direction will be referred to as a “second direction”, and the +z-axis direction or the −z-axis direction will be referred to as a “third direction”.

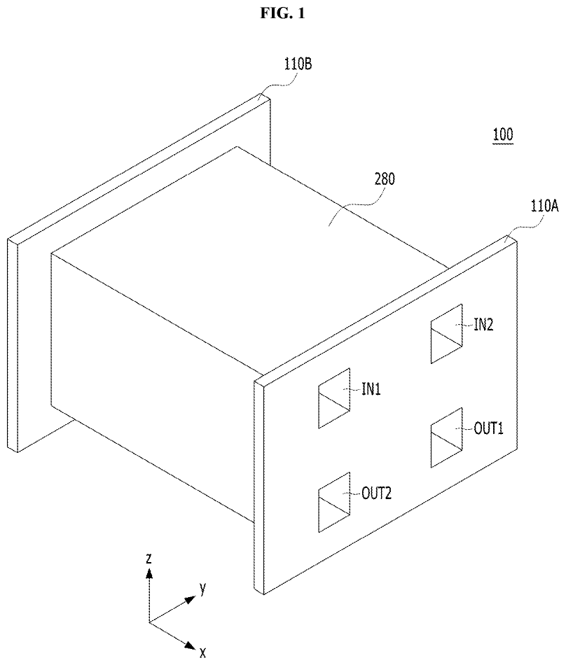

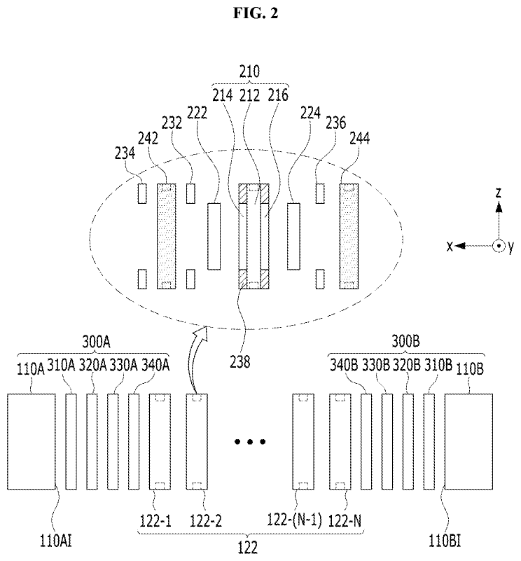

FIG. 1 is a perspective view showing the external appearance of a fuel cell 100 according to various exemplary embodiments of the present invention, and FIG. 2 is a cross-sectional view of an exemplary embodiment for explaining end plates (pressing plates or compressing plates) 110A and 110B, a cell stack 122, and heater assemblies 300A and 300B included in the fuel cell 100 according to the exemplary embodiment of the present invention. Illustration of the enclosure 280 shown in FIG. 1 is omitted from FIG. 2, and illustration of first and second connectors 400A and 400B is omitted from FIG. 1.

The fuel cell 100 may be, for example, a polymer electrolyte membrane fuel cell (or a proton exchange membrane fuel cell) (PEMFC), which has been studied most extensively as a power source for driving vehicles. However, the exemplary embodiments are not limited to any specific form of fuel cell.

The fuel cell 100 may include end plates 110A and 110B, a cell stack 122, an enclosure 280, and first and second heater assemblies 300A and 300B. Although it is illustrated in FIG. 2 that the fuel cell 100 includes the first and second end plates 110A and 110B and the first and second heater assemblies 300A and 300B, the exemplary embodiments are not limited thereto. That is, according to another exemplary embodiment of the present invention, the fuel cell 100 may include only one of the first and second end plates 110A and 110B and only one of the first and second heater assemblies 300A and 300B.

Hereinafter, the fuel cell 100 according to the exemplary embodiment will be referred to as including both the first heater assembly 300A and the second heater assembly 300B. However, the following description may also apply to the case in which the fuel cell 100 includes only one of the first and second heater assemblies 300A and 300B.

Among the components of the first and second heater assemblies 300A and 300B, first and second connectors 400A and 400B are respectively included in the first and second end plates 110A and 110B, and thus the first and second heater assemblies 300A and 300B are shown in FIG. 2 as including the first and second end plates 110A and 110B.

The enclosure 280 shown in FIG. 1 may be coupled to the end plates 110A and 110B, and may be disposed to surround at least a portion of the side portions of the cell stack 122 which is disposed between the end plates 110A and 110B. The enclosure 280 is configured to clamp a plurality of unit cells together with the end plates 110A and 110B in the first direction thereof. In other words, the clamping pressure of the cell stack 122 may be maintained by the end plates 110A and 110B, which has rigid body structure, and the enclosure 280. However, the clamping pressure of the cell stack 122 may be maintained without using the enclosure 280. The exemplary embodiments are not limited to any specific configuration for maintaining the clamping pressure.

The first and second end plates 110A and 110B may be disposed at respective end portions of the cell stack 122, and may support and fix a plurality of unit cells. That is, the first end plate 110A may be disposed at one of the two end portions of the cell stack 122, and the second end plate 110B may be disposed at the other one of the two end portions of the cell stack 122.

The fuel cell 100 may include a plurality of manifolds. The manifolds may include a first inlet communication portion (or a first inlet manifold) IN1, a second inlet communication portion (or a second inlet manifold) IN2, a third inlet communication portion (or a third inlet manifold) IN3, a first outlet communication portion (or a first outlet manifold) OUT1, a second outlet communication portion (or a second outlet manifold) OUT2, and a third outlet communication portion (or a third outlet manifold) OUT3.

One of the first and second inlet communication portions IN1 and IN2 may be a hydrogen inlet through which hydrogen, which is a reactant gas, is introduced into the cell stack 122 from the outside, and the other one of the first and second inlet communication portions IN1 and IN2 may be an oxygen inlet (or an air inlet) through which oxygen, which is a reactant gas, is introduced into the cell stack 122 from the outside. Furthermore, one of the first and second outlet communication portions OUT1 and OUT2 may be a hydrogen outlet through which hydrogen, which is a reactant gas, and condensate water are discharged out of the cell stack 122, and the other one of the first and second outlet communication portions OUT1 and OUT2 may be an oxygen outlet (or an air outlet) through which oxygen, which is a reactant gas, and condensate water are discharged out of the cell stack 122.

Further, the third inlet communication portion IN3 may be a coolant inlet through which a cooling medium (e.g., coolant) is introduced from the outside, and the third outlet communication portion OUT3 may be a coolant outlet through which a cooling medium is discharged to the outside.

Hereinafter, for convenience of description, the first inlet communication portion IN1 will be referred to as an oxygen inlet, the second inlet communication portion IN2 will be referred to as a hydrogen inlet, the first outlet communication portion OUT1 will be referred to as an oxygen outlet, the second outlet communication portion OUT2 will be referred to as a hydrogen outlet, the third inlet communication portion IN3 will be referred to as a coolant inlet, and the third outlet communication portion OUT3 will be referred to as a coolant outlet.

The oxygen outlet OUT1 and the hydrogen outlet OUT2 may be disposed below the oxygen inlet IN1 and the hydrogen inlet IN2, the oxygen inlet IN1 and the oxygen outlet OUT1 may be disposed at positions separated from each other in a diagonal direction, and the hydrogen inlet IN2 and the hydrogen outlet OUT2 may be disposed at positions separated from each other in a diagonal direction thereof. Due to the present arrangement, condensate water may be discharged from the lower portions of the unit cells included in the cell stack 122, or may remain in the lower portions of the unit cells due to gravity.

According to various exemplary embodiments of the present invention, the oxygen and hydrogen inlets IN1 and IN2 and the oxygen and hydrogen outlets OUT1 and OUT2 may be included in any one of the first and second end plates 110A and 110B (e.g., the first end plate 110A, as shown in FIG. 1), and the coolant inlet IN3 and the coolant outlet OUT3 may be included in the other one of the first and second end plates 110A and 110B (e.g., the second end plate 110B shown in FIG. 1).

According to another exemplary embodiment of the present invention, all of the oxygen inlet IN1, the hydrogen inlet IN2, the coolant inlet IN3, the oxygen outlet OUT1, the hydrogen outlet OUT2, and the coolant outlet OUT3 may be included in any one of the first and second end plates 110A and 110B.

Referring to FIG. 2, the cell stack 122 may include a plurality of unit cells 122-1 to 122-N, which are stacked in the first direction thereof. Here, “N” is a positive integer of 1 or greater, and may range from several tens to several hundreds. “N” may be determined depending on the intensity of the power to be supplied from the fuel cell 100 to a load. Here, “load” may refer to a part requiring power in a vehicle that utilizes a fuel cell.

Each unit cell 122-n may include a membrane electrode assembly (MEA) 210, gas diffusion layers (GDLs) 222 and 224, gaskets 232, 234, and 236, and separators (or bipolar plates) 242 and 244. Here, 1≤n≤N.

The membrane electrode assembly 210 has a structure in which catalyst electrode layers, in which electrochemical reactions occur, are attached to both sides of an electrolyte membrane through which hydrogen ions move. The membrane electrode assembly 210 may include a polymer electrolyte membrane (or a proton exchange membrane) 212, a fuel electrode (a hydrogen electrode or an anode) 214, and an air electrode (an oxygen electrode or a cathode) 216. Furthermore, the membrane electrode assembly 210 may further include a sub-gasket 238.

The polymer electrolyte membrane 212 is disposed between the fuel electrode 214 and the air electrode 216.

Hydrogen, which is the fuel in the fuel cell 100, may be supplied to the fuel electrode 214 through the first separator 242, and air containing oxygen as an oxidizer may be supplied to the air electrode 216 through the second separator 244.

The hydrogen supplied to the fuel electrode 214 is decomposed into hydrogen ions (protons) (H+) and electrons (e−) by the catalyst. The hydrogen ions alone may be selectively transferred to the air electrode 216 through the polymer electrolyte membrane 212, and at the same time, the electrons may be transferred to the air electrode 216 through the gas diffusion layers 222 and 224 and the separators 242 and 244, which are conductors. To realize the above operation, a catalyst layer may be applied to each of the fuel electrode 214 and the air electrode 216. The movement of the electrons described above causes the electrons to flow through an external wire, thus generating current. That is, the fuel cell 100 may generate electric power due to the electrochemical reaction between hydrogen, which is the fuel, and oxygen contained in the air.

In the air electrode 216, the hydrogen ions supplied through the polymer electrolyte membrane 212 and the electrons transferred through the separators 242 and 244 meet oxygen in the air supplied to the air electrode 216, thus causing a reaction that generates water (hereinafter referred to as “condensate water” or “product water”). The condensate water generated in the air electrode 216 may penetrate the polymer electrolyte membrane 212 and may be transferred to the fuel electrode 214.

In some cases, the fuel electrode 214 may be referred to as an anode, and the air electrode 216 may be referred to as a cathode. Alternatively, the fuel electrode 214 may be referred to as a cathode, and the air electrode 216 may be referred to as an anode.

The gas diffusion layers 222 and 224 are configured to uniformly distribute hydrogen and oxygen, which are reactant gases, and to transfer the generated electrical energy. To the present end, the gas diffusion layers 222 and 224 may be disposed on respective sides of the membrane electrode assembly 210. That is, the first gas diffusion layer 222 may be disposed on the left side of the fuel electrode 214, and the second gas diffusion layer 224 may be disposed on the right side of the air electrode 216.

The first gas diffusion layer 222 is configured to diffuse and uniformly distribute hydrogen supplied as a reactant gas through the first separator 242, and may be electrically conductive.

The second gas diffusion layer 224 is configured to diffuse and uniformly distribute air supplied as a reactant gas through the second separator 244, and may be electrically conductive.

Each of the first and second gas diffusion layers 222 and 224 may be a microporous layer in which fine carbon fibers are combined. However, the exemplary embodiments are not limited to any specific forms of the first and second gas diffusion layers 222 and 224.

The gaskets 232, 234, and 236 are configured to maintain the airtightness and clamping pressure of the cell stack at an appropriate level with respect to the reactant gases and the coolant, to disperse the stress when the separators 242 and 244 are stacked, and to independently seal the flow paths. Accordingly, since airtightness and watertightness are maintained by the gaskets 232, 234, and 236, the flatness of the surfaces that are adjacent to the cell stack 122, which generates electric power, may be secured, and thus surface pressure may be distributed uniformly over the reaction surfaces of the cell stack 122.

The separators 242 and 244 is configured to move the reactant gases and the cooling medium and to separate each of the unit cells from the other unit cells. Furthermore, the separators 242 and 244 is configured to structurally support the membrane electrode assembly 210 and the gas diffusion layers 222 and 224 and to collect the generated current and transfer the collected current to current-collecting plates 340A and 340B.

The separators 242 and 244 may be respectively disposed outside the gas diffusion layers 222 and 224. That is, the first separator 242 may be disposed on the left side of the first gas diffusion layer 222, and the second separator 244 may be disposed on the right side of the second gas diffusion layer 224.

The first separator 242 is configured to supply hydrogen as a reactant gas to the fuel electrode 214 through the first gas diffusion layer 222. To the present end, the first separator 242 may include an anode plate (AP), in which a channel (i.e., a passage or a flow path) is formed so that hydrogen may flow therethrough.

The second separator 244 is configured to supply air as a reactant gas to the air electrode 216 through the second gas diffusion layer 224. To the present end, the second separator 244 may include a cathode plate (CP), in which a channel is formed so that air containing oxygen may flow therethrough. Furthermore, each of the first and second separators 242 and 244 may form a channel through which a cooling medium may flow.

Further, the separators 242 and 244 may be made of a graphite-based material, a composite graphite-based material, or a metal-based material. However, the exemplary embodiments are not limited to any specific material of the separators 242 and 244.

For example, each of the first and second separators 242 and 244 may include the oxygen inlet IN1, the hydrogen inlet IN2, the coolant inlet IN3, the oxygen outlet OUT1, the hydrogen outlet OUT2, and the coolant outlet OUT3.

In other words, the reactant gases required for the membrane electrode assembly 210 may be introduced into the cell through the oxygen and hydrogen inlets IN1 and IN2, and gas or liquid, in which the reactant gases humidified and supplied to the cell and the condensate water generated in the cell are combined, may be discharged to the outside of the fuel cell 100 through the oxygen and hydrogen outlets OUT1 and OUT2.

Furthermore, the fuel cell 100 may further include a heater assembly. The heater assembly is configured to raise the temperature of the cell stack 122 when starting the cell stack 122 in a cooled state. To the present end, the heater assembly may include at least one of the first heater assembly 300A or the second heater assembly 300B.

Hereinafter, as shown in FIG. 2, the heater assembly will be referred to as including both the first heater assembly 300A and the second heater assembly 300B, but the exemplary embodiments are not limited thereto. That is, the following description may also apply to the case in which the heater assembly includes only one of the first and second heater assemblies 300A and 300B.

The first heater assembly 300A may be disposed at the cell 122-1, which is located at one of the two end portions of the cell stack 122, and the second heater assembly 300B may be disposed at the cell 122-N, which is located at the other one of the two end portions of the cell stack 122.

Referring to FIG. 2, the first heater assembly 300A may include a first current-collecting plate 340A, a first heating element 330A, a first heater plate 310A, and a first end plate 110A.

Furthermore, the second heater assembly 300B may include a second current-collecting plate 340B, a second heating element 330B, a second heater plate 310B, and a second end plate 110B.

The first current-collecting plate 340A may be omitted from the first heater assembly 300A, and the second current-collecting plate 340B may be omitted from the second heater assembly 300B.

The first current-collecting plate 340A may be disposed between the first end plate 110A, which faces the cell stack 122, and the cell stack 122, and the second current-collecting plate 340B may be disposed between the second end plate 110B, which faces the cell stack 122, and the cell stack 122. In other words, the first current-collecting plate 340A included in the first heater assembly 300A may be disposed between the first heating element 330A and one (e.g., 122-1) of the two end portions of the cell stack 122. The second current-collecting plate 340B included in the second heater assembly 300B may be disposed between the second heating element 330B and the other one (e.g., 122-N) of the two end portions of the cell stack 122.

Each of the first and second current-collecting plates 340A and 340B is configured to collect electrical energy generated by the flow of electrons in the cell stack 122 for supply of the same to a load of a vehicle in which the fuel cell 100 is used. For example, each of the first and second current-collecting plates 340A and 340B may be implemented as a metal plate, which is electrically conductive, and may be electrically connected to the cell stack 122.

Each of the first and second heater plates 310A and 310B is conceptually a dummy cell, which is a unit cell disposed at the outermost position in the first direction in which the unit cells 122-n are stacked in the cell stack 122, and may be formed in a plate shape corresponding to the external shape of the unit cells 122-n.

Furthermore, the first and second heater plates 310A and 310B may also have communication portions penetrating both side surfaces thereof in the first direction, for example, oxygen and hydrogen inlets IN1 and IN2, oxygen and hydrogen outlets OUT1 and OUT2, a coolant inlet IN3, and a coolant outlet OUT3.

Hereinafter, the first heater plate 310A will be referred to as including the oxygen and hydrogen inlets IN1 and IN2 and the oxygen and hydrogen outlets OUT1 and OUT2, and the second heater plate 310B will be referred to as including the coolant inlet IN3 and the coolant outlet OUT3.

Further, each of the first and second heater plates 310A and 310B may be implemented as one bypass plate. In the instant case, the first end plate 110A may be modularized with the first heater plate 310A, and the second end plate 110B may be modularized with the second heater plate 310B.

The heater plate may be disposed at at least one of the two end portions 122-1 and 122-N of the cell stack 122. For example, the first heater plate 310A may be disposed between the internal surface 110AI of the first end plate 110A and one (e.g., 122-1) of the two end portions of the cell stack 122, and the second heater plate 310B may be disposed between the internal surface 110BI of the second end plate 110B and the other one (e.g., 122-N) of the two end portions of the cell stack 122.

Further, each of the first and second heater plates 310A and 310B may be configured such that a metallic pipe is integrally formed with a plastic body through insert injection molding, and the pipe may form a flow channel (e.g., a hydrogen channel and an oxygen channel). However, the exemplary embodiments are not limited to any specific material of each of the first and second heater plates 310A and 310B.

Referring to FIG. 2, the first heating element 330A may be mounted to the first heater plate 310A, and the second heating element 330B may be mounted to the second heater plate 310B.

For example, each of the first and second heating elements 330A and 330B may include a heating portion, which is composed of a carbon paste and an electrode, and a protective film portion, which is configured such that a polyethylene terephthalate (PET) layer disposed on both surfaces of the heating portion, an aluminum layer disposed on both surfaces of the PET layer, and a PET layer disposed on both surfaces of the aluminum layer are sequentially stacked.

Further, in each of the first and second heating elements 330A and 330B, the pattern of the heating portion, which is composed of the carbon paste and the electrode, may be variously formed, and the heat density may be adjusted for each portion by changing the pattern of the heating portion. Furthermore, each of the first and second heating elements 330A and 330B may be implemented as a planar heating element, for example, a polymer positive temperature coefficient (PTC) heating element. If moisture permeates the carbon paste exhibiting a PTC function for a long time, heating performance deteriorates. To prevent permeation of moisture, a PET film is attached to the carbon paste and the electrode, enhancing resistance to moisture.

Each of the first and second heating elements 330A and 330B may be further provided with an aluminum thin film and a PET film, which exhibit high resistance to moisture. In the instant case, to prevent the withstand voltage performance from being deteriorated by aluminum, which is conductive, the aluminum thin film may be manufactured to have a smaller size than the PET film, improving not only moisture resistance characteristics but also withstand voltage characteristics.

Each of the first and second heating elements 330A and 330B may generate heat by driving power (a driving signal, driving voltage, or driving current).

Further, although not shown, thermal grease or a thermal pad may be located between the first heating element 330A and the first current-collecting plate 340A and between the second heating element 330B and the second current-collecting plate 340B to be in close contact therewith. Due to the thermal pad or the thermal grease located between the first and second heating elements 330A and 330B and the first and second current-collecting plates 340A and 340B to improve the heat conduction function, the heat generated from the first and second heating elements 330A and 330B may be efficiently transferred to the reaction cells 122-n of the cell stack 122 via the first and second current-collecting plates 340A and 340B.

Furthermore, the first heater assembly 300A may further include a first pad 320A, and the second heater assembly 300B may further include a second pad 320B.

The first and second pads 320A and 320B block the heat generated from the first and second heating elements 330A and 330B from traveling in the direction in which the cell stack 122 faces the first and second end plates 110A and 110B, thus allowing a larger amount of heat to travel to the cell stack 122. In the present way, the first and second pads 320A and 320B may perform a thermal insulation function for preventing heat loss.

Furthermore, the first and second pads 320A and 320B is configured to buffer the clamping pressure of the cell stack 122. To the present end, the first pad 320A may be disposed between the first heater plate 310A and the first heating element 330A, and the second pad 320B may be disposed between the second heater plate 310B and the second heating element 330B. For example, each of the first and second pads 320A and 320B may be implemented as a foamed silicon sheet, and may prevent damage to the film-type first and second heating elements 330A and 330B when assembled with the first and second heater plates 310A and 310B and the first and second heating elements 330A and 330B to be in close contact therewith in a stacking manner. However, the exemplary embodiments are not limited to any specific material of each of the first and second pads 320A and 320B. Alternatively, at least one of the first pad 320A or the second pad 320B may be omitted from the fuel cell 100 according to the embodiment.

Hereinafter, an exemplary embodiment of each of the first and second heater assemblies 300A and 300B will be described in more detail with reference to the accompanying drawings.

Furthermore, the following description will be made with reference to the configuration in which the first end plate 110A includes the oxygen inlet IN1, the hydrogen inlet IN2, the oxygen outlet OUT1, and the hydrogen outlet OUT2 and in which the second end plate 110B includes the coolant inlet IN3 and the coolant outlet OUT3. However, the exemplary embodiments are not limited thereto. That is, the following description may also apply to the case in which one of the first and second end plates 110A and 110B includes all of the oxygen inlet IN1, the hydrogen inlet IN2, the oxygen outlet OUT1, the hydrogen outlet OUT2, the coolant inlet IN3, and the coolant outlet OUT3.

First, an exemplary embodiment of the first heater assembly 300A will be described.

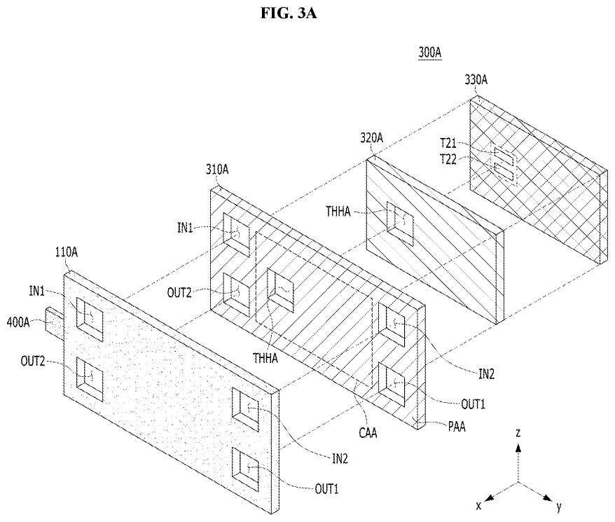

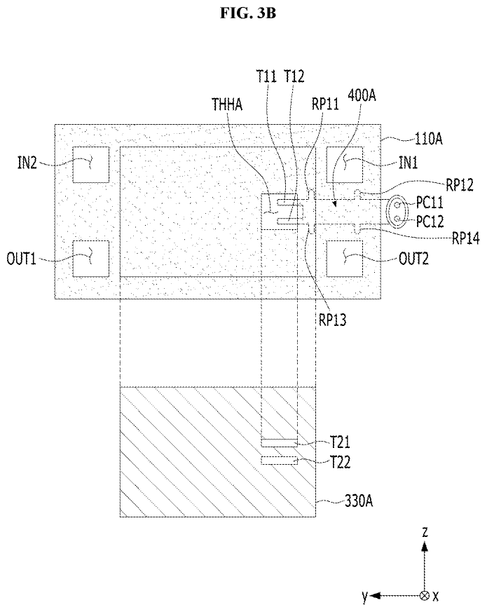

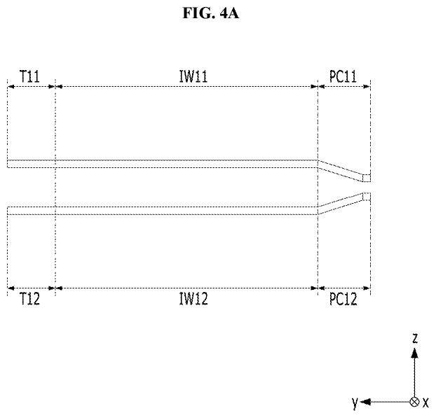

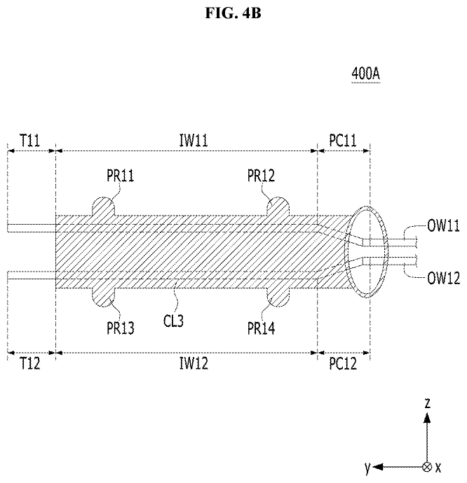

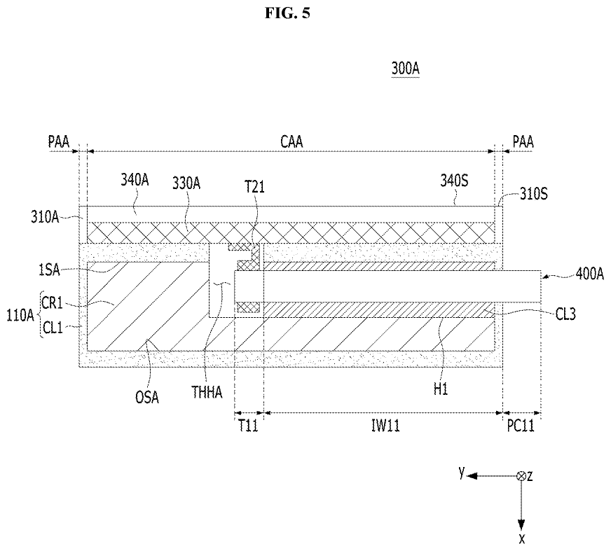

FIG. 3A is an exploded perspective view of an exemplary embodiment of the first heater assembly 300A, FIG. 3B is a view showing the disassembled state of the first heating element 330A and the first end plate 110A accommodating the first connector 400A, FIG. 4A and FIG. 4B are rear views of the first connector 400A, and FIG. 5 is a cross-sectional view of the exemplary embodiment of the first heater assembly 300A.

For better understanding, illustration of the first current-collecting plate 340A is omitted from FIG. 3A and FIG. 3B, illustration of the first heater plate 310A and the first pad 320A shown in FIG. 3A is omitted from FIG. 3B, and the portion of the first connector 400A which is covered by a first clad CL1 is denoted by a dotted line in FIG. 3B. Furthermore, among the components of the first connector 400A, first and second internal wires IW11 and IW12, which are covered by a third clad CL3, are denoted by dotted lines in FIG. 4B.

Each of the first and second end plates 110A and 110B may be configured such that a core (or a metallic insert) is enveloped by a clad (or an insert injection molded part).

A first core CR1 of the first end plate 110A may have first rigidity to withstand internal surface pressure, and a first clad CL1 may have second rigidity which is lower than the first rigidity. A second core CR2 of the second end plate 110B may have third rigidity to withstand internal surface pressure, and a second clad CL2 may have fourth rigidity which is less than the third rigidity. To the present end, the first and second cores CR1 and CR2 may be formed by machining a metal material. However, the exemplary embodiments are not limited to any specific method of forming the first and second cores CR1 and CR2.

For example, the first and second cores CR1 and CR2 may be made of a metal material (e.g., aluminum (Al)), and the first and second dads CL1 and CL2 may be made of resin. Here, the resin may be synthetic resin rubber or plastic, but the exemplary embodiments are not limited to any specific resin material.

Referring to FIG. 5, the first end plate 110A is configured such that the first core CR1 is enveloped by the first clad CL1. The first clad CL1 may be applied to the entire area of the first core CR1, or may be applied only to a portion of the first core CR1.

The first connector 400A is accommodated in the first core CR1 of the first end plate 110A and is covered by the first clad CL1, and electrically interconnects a driving power supply and the first heating element 330A.

To the present end, the first connector 400A may include power connection portions PC11 and PC12, first and second internal wires IW11 and IW12, and first and second terminal portions T11 and T12.

The power connection portions PC11 and PC12 may include a positive terminal PC11 and a negative terminal PC12, which are connected to the driving power supply.

The first internal wire IW11 has one end portion connected to the positive terminal PC11 of the power connection portions and an opposite end portion connected to the first terminal portion T11. The second internal wire IW12 has one end portion connected to the negative terminal PC12 of the power connection portions and an opposite end portion connected to the second terminal portion T12.

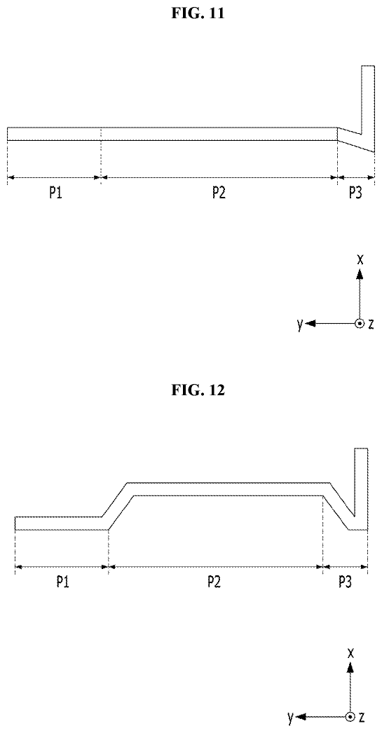

According to the exemplary embodiment of the present invention, at least one of the first internal wire IW11 or the second internal wire IW12 may have a flat shape without a stepped portion. For example, the first or second internal wire IW11 or IW12 may have a flat cross-sectional shape, without being bent in the first direction thereof. An exemplary cross-sectional shape thereof is shown in FIG. 11, which will be described later.

Referring to FIG. 5, the first internal wire IW11 of the first connector 400A may be accommodated in the first core CR1, and may be covered by the first clad CL1. Similarly, the second internal wire IW12 may be accommodated in the first core CR1, and may be covered by the first clad CL1.

The first core CR1 may include a first internal surface ISA and a first external surface OSA. The first internal surface ISA is a surface that faces one end portion (e.g., 122-1) of the cell stack 122 in the first direction, and the first external surface OSA is a surface formed opposite to the first internal surface ISA. The first internal surface ISA may have a first groove H1 formed therein to have a concavely depressed cross-sectional shape, and the first and second internal wires IW11 and IW12 may be received in the first groove H1.

Referring to FIGS. 4B and 5, the first and second internal wires IW11 and IW12 of the first connector 400A are enveloped by the third clad CL3. The first and second internal wires IW11 and IW12 may be mounted, fixed, or received in the first groove H1 in the state of being enveloped by the third clad CL3. Hereinafter, as shown in FIG. 4B, the result obtained by enveloping the first and second internal wires IW11 and IW12 and the power connection portions PC11 and PC12 using the third clad CL3 will be referred to as a “first premolded connector”.

The third clad CL3 may include first and second fixing portions PR11, PR12, PR13, and PR14. The first fixing portions PR11 and PR12 are disposed between the power connection portion PC11 and the first terminal portion T11 and protrude in the third direction, which intersects the second direction, in which the power connection portion PC11 and the first terminal portion T11 face each other, fixing one side of the first premolded connector 400A to the first core CR1. The second fixing portions PR13 and PR14 are disposed between the power connection portion PC12 and the second terminal portion T12 and protrude in the third direction, which intersects the second direction, in which the power connection portion PC12 and the second terminal portion T12 face each other, fixing the opposite side of the first premolded connector 400A to the first core CR1. Although it is illustrated in FIG. 4B that the number of first fixing portions is two and the number of second fixing portions is two, the exemplary embodiments are not limited thereto. That is, according to another exemplary embodiment of the present invention, the number of first fixing portions may be one or three or more, and the number of second fixing portions may be one or three or more.

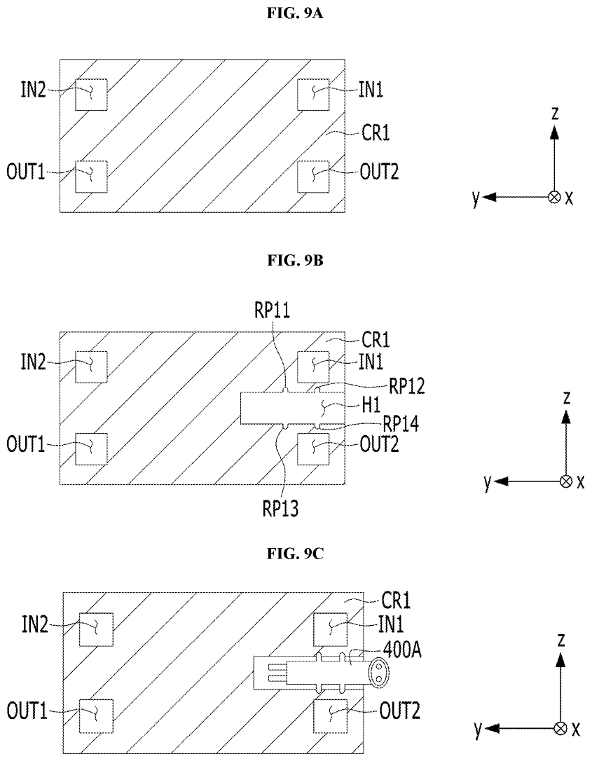

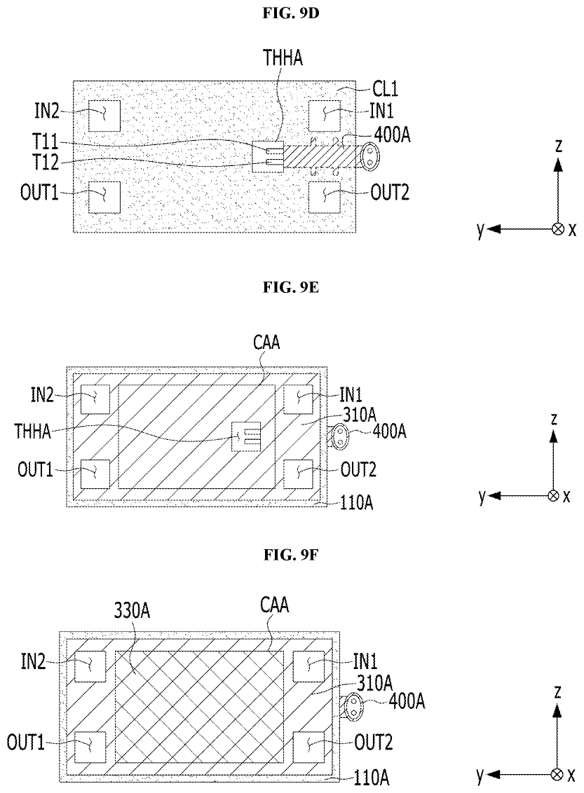

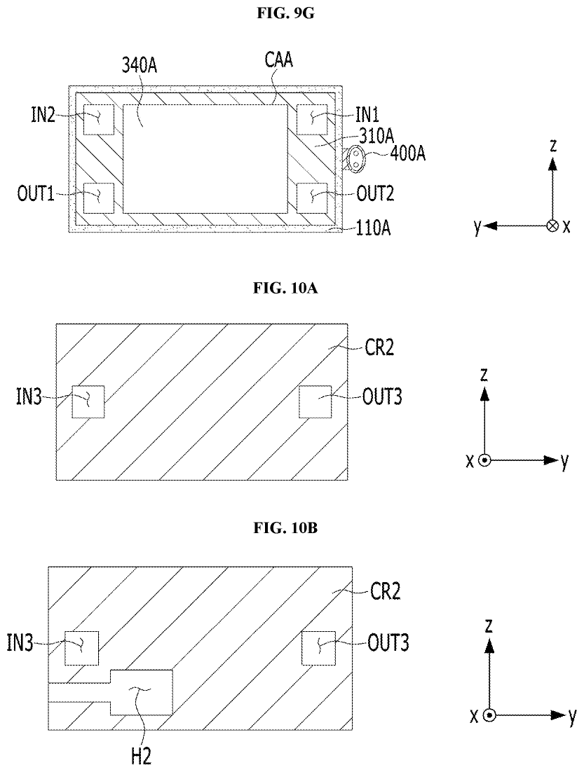

As described above, when the first premolded connector 400A includes the first and second fixing portions, the first core CR1 may include first and second concave portions RP11, RP12, RP13, and RP14, as shown in FIG. 9B, which will be described later. The first concave portions RP11 and RP12 are configured to receive the first fixing portions PR11 and PR12 therein, and the second concave portions RP13 and RP14 are configured to receive the second fixing portions PR13 and PR14 therein. The number of first concave portions is equal to the number of first fixing portions, and the number of second concave portions is equal to the number of second fixing portions.

Further, the first groove H1, the first concave portions RP11 and RP12, and the second concave portions RP13 and RP14 may be blind holes, rather than through-holes penetrating the first core CR1.

As described above, when the first end plate 110A includes the oxygen inlet IN1, the hydrogen inlet IN2, the oxygen outlet OUT1, and the hydrogen outlet OUT2, the first and second concave portions RP11, RP12, RP13, and RP14 and the first groove H1 may be formed in regions of the first core CR1 other than the regions thereof in which the oxygen inlet IN1, the hydrogen inlet IN2, the oxygen outlet OUT1, and the hydrogen outlet OUT2 are disposed. In other words, the first and second concave portions RP11 to RP14 and the first groove H1 may be spaced from the oxygen inlet IN1, the hydrogen inlet IN2, the oxygen outlet OUT1, and the hydrogen outlet OUT2. In one example, as shown in FIG. 3B and FIG. 9B to be described later, the first and second concave portions RP11 to RP14 and the first groove H1 may be disposed between the oxygen inlet IN1 and the hydrogen outlet OUT2.

Furthermore, the first heating element 330A may include a third terminal portion T21 and a fourth terminal portion T22, which are respectively coupled to the first terminal portion T11 and the second terminal portion T12. For example, as shown in FIG. 5, the first terminal portion T11 may be coupled to the third terminal portion T21, and the second terminal portion T12 may be coupled to the fourth terminal portion T22. The exemplary embodiments are not limited to any specific coupling manner between the first and third terminal portions T11 and T21 or any specific coupling manner between the second and fourth terminal portions T12 and T22.

Furthermore, as shown in FIGS. 3A, 3B, and 5, each of the first end plate 110A, the first heater plate 310A, and the first pad 320A may include therein a first terminal-mounting hole THHA. The first terminal-mounting hole THHA formed in the first end plate 110A may be a blind hole, and the first terminal-mounting hole THHA formed in each of the first heater plate 310A and the first pad 320A may be a through-hole.

The first terminal-mounting hole THHA in the first end plate 110A may expose the first and second terminal portions T11 and T12. The third and fourth terminal portions T21 and T22 of the first heating element 330A may penetrate the first terminal-mounting hole THHA formed in each of the first heater plate 310A and the first pad 320A to slide into the first terminal-mounting hole THHA formed in the first end plate 110A, and may be coupled and fixed to the first and second terminal portions T11 and T12.

Next, an exemplary embodiment of the second heater assembly 300B will be described below.

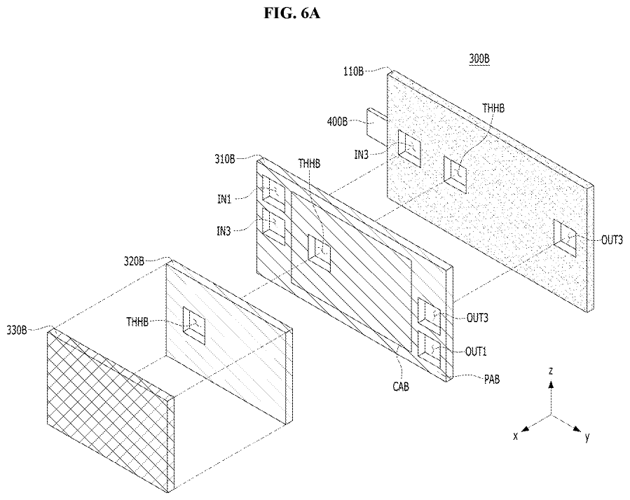

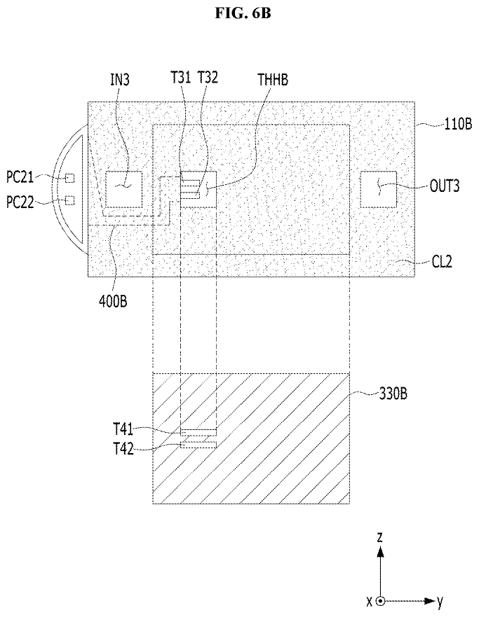

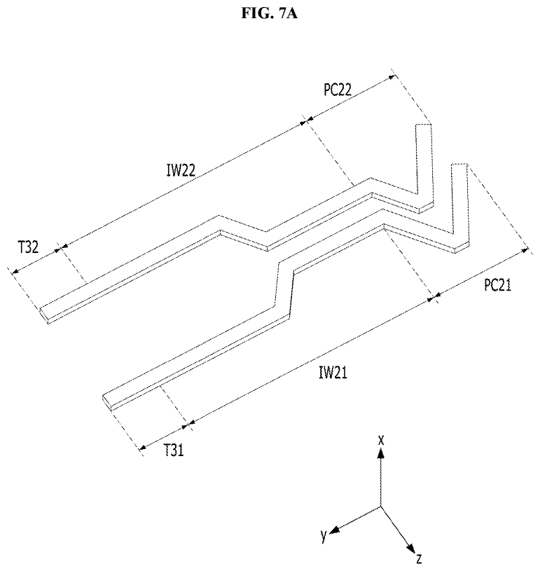

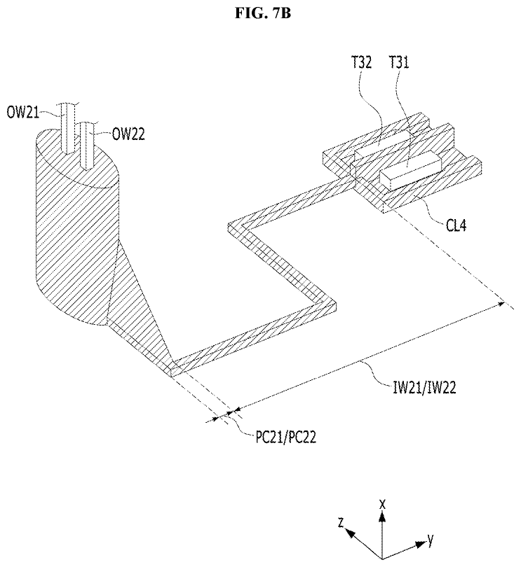

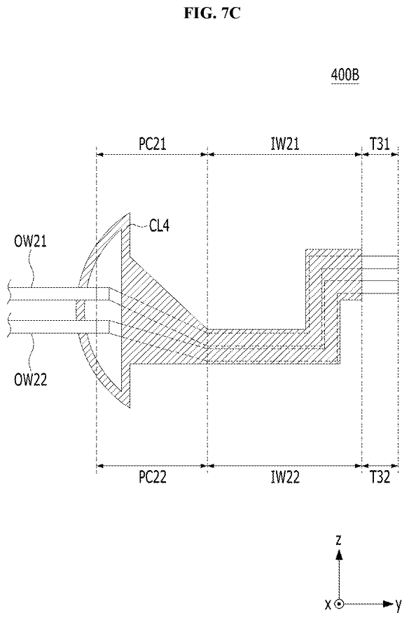

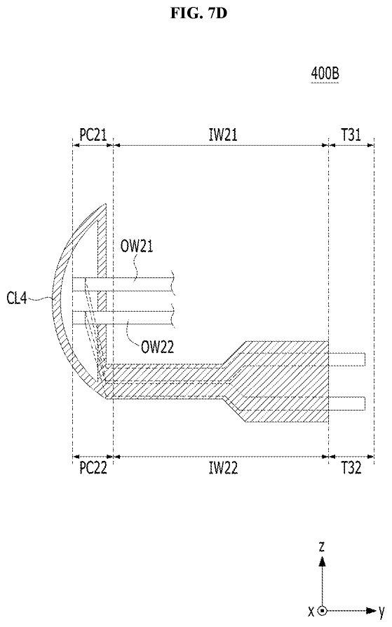

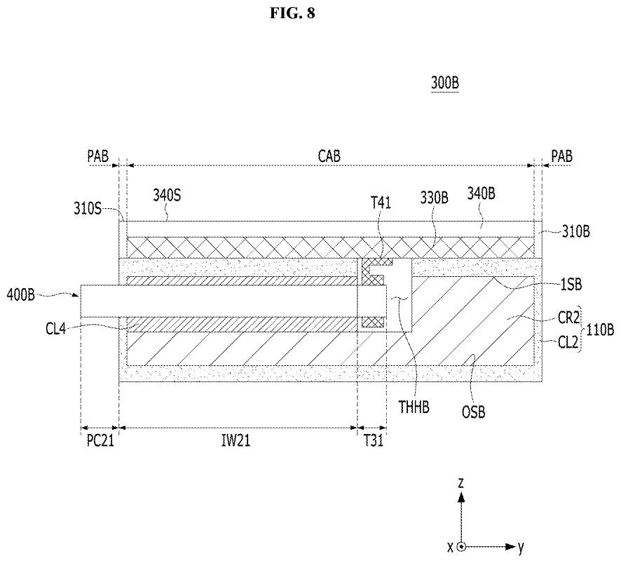

FIG. 6A is an exploded perspective view of an exemplary embodiment of the second heater assembly 300B, FIG. 6B is a view showing the disassembled state of the second heating element 330B and the second end plate 110B accommodating the second connector 400B, FIG. 7A, FIG. 7B, FIG. 7C, and FIG. 7D are views showing an exemplary embodiment of the second connector, and FIG. 8 is a cross-sectional view of the exemplary embodiment of the second heater assembly 300B.

For better understanding, illustration of the second current-collecting plate 340B is omitted from FIG. 6A and FIG. 6B, illustration of the second heater plate 310B and the second pad 320B shown in FIG. 6A is omitted from FIG. 6B, and the portion of the second connector 400B which is covered by the second clad CL2 is denoted by a dotted line in FIG. 6B. Furthermore, among the components of the second connector 400B, the portions covered by a fourth clad CL4 are denoted by dotted lines in FIGS. 7C and 7D.

Referring to FIG. 8, the second end plate 110B may be configured such that the second core CR2 is enveloped by the second clad CL2. The second clad CL2 may be applied to the entire area of the second core CR2, or may be applied only to a portion of the second core CR2.

The second connector 400B is accommodated in the second core CR2 of the second end plate 110B and is covered by the second clad CL2, and electrically interconnects the driving power supply and the second heating element 330B.

The second connector 400B may include power connection portions PC21 and PC22, first and second internal wires IW21 and IW22, and first and second terminal portions T31 and T32.

The power connection portions PC21 and PC22 may include a positive terminal PC21 and a negative terminal PC22, which are connected to the driving power supply.

The first internal wire IW21 has one end portion connected to the positive terminal PC21 of the power connection portions and an opposite end portion connected to the first terminal portion T31. The second internal wire IW22 has one end portion connected to the negative terminal PC22 of the power connection portions and an opposite end portion connected to the second terminal portion T32.

According to the exemplary embodiment of the present invention, at least one of the first internal wire IW21 or the second internal wire IW22 may have a flat shape without a stepped portion. For example, the first or second internal wire IW21 or IW22 may have a flat cross-sectional shape without being bent in the first direction. An exemplary cross-sectional shape thereof is shown in FIG. 11, which will be described later.

Referring to FIG. 8, the first internal wire IW21 of the second connector 400B may be accommodated in the second core CR2, and may be covered by the second clad CL2. Similarly, the second internal wire IW22 may be accommodated in the second core CR2, and may be covered by the second clad CL2.

The second core CR2 may include a second internal surface ISB and a second external surface OSB. The second internal surface ISB is a surface that faces the opposite end portion (e.g., 122-N) of the cell stack 122 in the first direction, and the second external surface OSB is a surface formed opposite to the second internal surface ISB. The second internal surface ISB may have a second groove H2 formed therein to have a concavely depressed cross-sectional shape, and the first and second internal wires IW21 and IW22 may be received in the second groove H2.

Referring to FIGS. 7B, 7C, 7D, and 8, the first and second internal wires IW21 and IW22 of the second connector 400B are enveloped by the fourth clad CL4. The first and second internal wires IW21 and IW22 may be mounted, fixed, or received in the second groove H2 in the state of being enveloped by the fourth clad CL4. Hereinafter, as shown in FIGS. 7B to 7D, the result obtained by enveloping the first and second internal wires IW21 and IW22 and the power connection portions PC21 and PC22 using the fourth clad CL4 will be referred to as a “second premolded connector”.

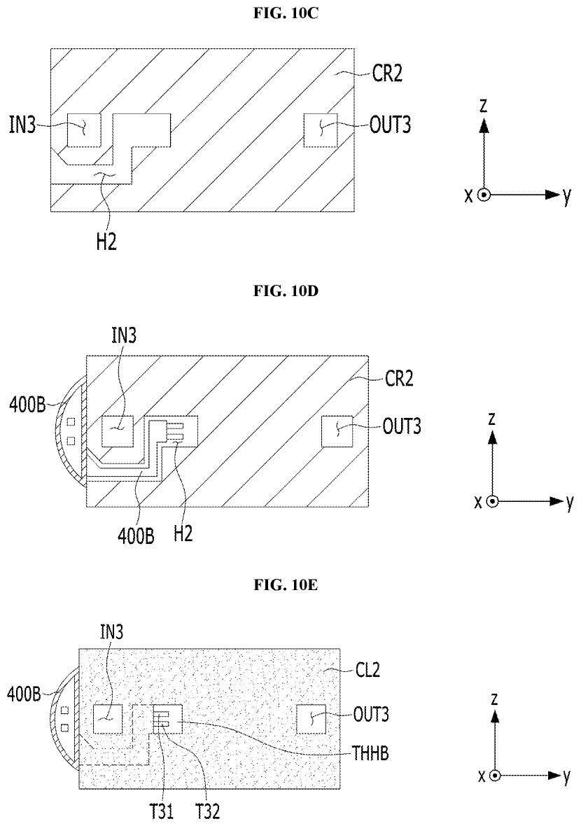

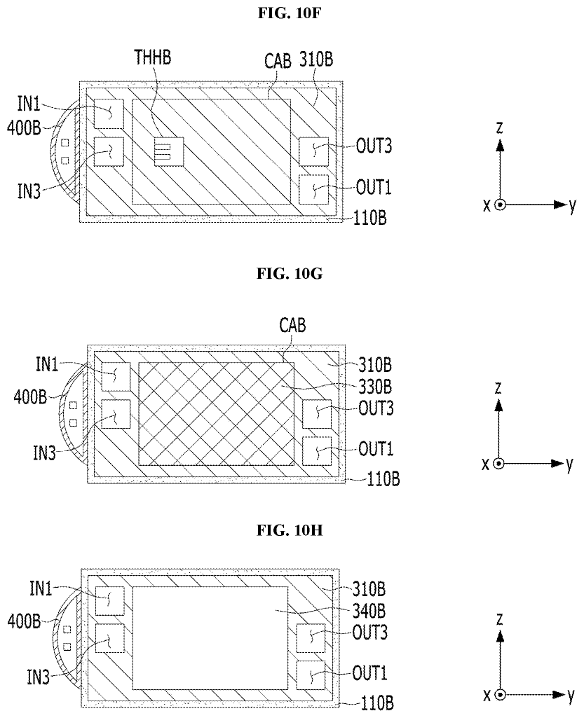

As described above, when the second end plate 110B includes the coolant inlet IN3 and the coolant outlet OUT3 and the second heater plate 310B includes the oxygen inlet IN1, the coolant inlet IN3, the oxygen outlet OUT1, and the coolant outlet OUT3, the second groove H2 may be formed in a region other than the regions in which the oxygen inlet IN1, the oxygen outlet OUT1, the coolant inlet IN3, and the coolant outlet OUT3 are disposed. In other words, the second groove H2 may be spaced from the oxygen inlet IN1, the coolant inlet IN3, the oxygen outlet OUT1, and the coolant outlet OUT3. In one example, as shown in FIG. 3B and FIG. 10B to be described later, the second groove H2 may be spaced from the coolant inlet IN3. Alternatively, as shown in FIG. 10C to be described later, the second groove H2 may bypass the coolant inlet IN3 and may be disposed between the coolant inlet IN3 and the coolant outlet OUT3.

Referring to FIG. 3B, since there is an empty space between the oxygen inlet IN1 and the hydrogen outlet OUT2 in the first end plate 110A, the first groove H1 may be formed in the present empty space. Accordingly, as shown in FIG. 4A, the first and second internal wires IW11 and IW12 may have a linear planar shape.

On the other hand, referring to FIG. 6B, it is necessary to form the second groove H2 to bypass the regions of the second end plate 110B in which the coolant inlet IN3 and the coolant outlet OUT3 are disposed and the regions of the second heater plate 310B in which the oxygen inlet IN1 and the oxygen outlet OUT1 are disposed. To the present end, as shown in FIG. 7A, FIG. 7B, FIG. 7C, and FIG. 7D, the first and second internal wires IW21 and IW22 may have a curved planar shape.

Referring to FIGS. 3A and 5, the first heater plate 310A may include a first central area CAA and a first peripheral area PAA. For better understanding, the first central area CAA, which is not visible in the first heater plate 310A shown in FIG. 3A, is indicated by a dotted line.

The first central area CAA is an area in which the first heating element 330A is disposed, and the first peripheral area PAA is an area formed adjacent to the first central area CAA.

Referring to FIGS. 6A and 8, the second heater plate 310B may include a second central area CAB and a second peripheral area PAB.

The second central area CAB is an area in which the second heating element 330B is disposed, and the second peripheral area PAB is an area formed adjacent to the second central area CAB.

According to the exemplary embodiment of the present invention, the first and second peripheral areas PA and PAB of the first and second heater plates 310A and 310B may have a flat cross-sectional shape. This will be described in more detail with reference to FIG. 11, which will be described later.

According to the exemplary embodiment of the present invention, the first current-collecting plate 340A may be disposed in the first central area CAA of the first heater plate 310A, and the second current-collecting plate 340B may be disposed in the second central area CAB of the second heater plate 310B. For example, the external surfaces 340S of the first and second current-collecting plates 340A and 340B disposed on the first and second heater plates 310A and 310B and the top portion surfaces 310S of the peripheral areas PAA and PAB of the first and second heater plates 310A and 310B may be located in the same horizontal plane. The reason for this is that, when the first and second heater assemblies 300A and 300B are coupled to respective end portions of the cell stack 122 to be in close contact therewith, the first and second current-collecting plates 340A and 340B are securely brought into close contact with the cell stack 122, realizing reliable electrical conduction.

Furthermore, the first and second current-collecting plates 340A and 340B and the first and second heating elements 330A and 330B are accommodated and received in the first and second central areas CAA and CAB, which are concavely formed, making it possible to easily fix these components 330A, 340A, 330B, and 340B at constant positions and to prevent separation after assembly thereof.

Furthermore, the second heating element 330B may include a third terminal portion T41 and a fourth terminal portion T42, which are respectively coupled to the first terminal portion T31 and the second terminal portion T32. For example, as shown in FIG. 8, the first terminal portion T31 may be coupled to the third terminal portion T41, and the second terminal portion T32 may be coupled to the fourth terminal portion T42. The exemplary embodiments are not limited to any specific coupling manner between the first and third terminal portions T31 and T41 or any specific coupling manner between the second and fourth terminal portions T32 and T42.

Furthermore, as shown in FIGS. 6A, 6B, and 8, each of the second end plate 110B, the second heater plate 310B, and the second pad 320B may include therein a second terminal-mounting hole THHB. The second terminal-mounting hole THHB formed in the second end plate 110B may be a blind hole, and the second terminal-mounting hole THHB formed in each of the second heater plate 310B and the second pad 320B may be a through-hole.

The second terminal-mounting hole THHB in the second end plate 110B may expose the first and second terminal portions T31 and T32. The third and fourth terminal portions T41 and T42 of the second heating element 330B may penetrate the second terminal-mounting hole THHB formed in each of the second heater plate 310B and the second pad 320B to slide into the second terminal-mounting hole THHB formed in the second end plate 110B, and may be coupled and fixed to the first and second terminal portions T31 and T32.

Hereinafter, an exemplary embodiment of a method of manufacturing the fuel cell 100 according to the exemplary embodiment described above will be described with reference to FIG. 9A, FIG. 9B, FIG. 9C, FIG. 9D, FIG. 9E, FIG. 9F, FIG. 9G, FIG. 10A, FIG. 10B, FIG. 10C, FIG. 10D, FIG. 10E, FIG. 10F, FIG. 10G, and FIG. 10H. In the following description, the same portions as the first and second heater assemblies 300A and 300B of the fuel cell 100 described above are denoted by the same reference numerals, and a duplicate description thereof will be omitted.

First, a method of manufacturing the first heater assembly 300A will be described below.

FIG. 9A, FIG. 9B, FIG. 9C, FIG. 9D, FIG. 9E, FIG. 9F and FIG. 9G are views for explaining a method of manufacturing the first heater assembly 300A of the fuel cell 100.

Referring to FIG. 9A, a first core CR1 having first rigidity, which is a component of a first end plate 110A, which is to be disposed at one of the two end portions of a cell stack 122, is prepared. For example, as shown in the drawings, an oxygen inlet IN1, a hydrogen inlet IN2, an oxygen outlet OUT1, and a hydrogen outlet OUT2 may be formed in the first core CR1. For example, the oxygen inlet IN1, the hydrogen inlet IN2, the oxygen outlet OUT1, and the hydrogen outlet OUT2 may be formed by manufacturing the first core CR1 of the first end plate 110A through casting.

Thereafter, as shown in FIG. 9B, the first core CR1 is machined to form a first groove H1 in the first core CR1. Here, the first groove H1 may have a blind hole shape, as shown in FIG. 5.

Thereafter, as shown in FIG. 9C, a first connector 400A is mounted in the first groove H1. At the instant time, as shown in FIG. 4B, the first connector 400A may be enveloped by a third clad CL3, which is provided separately from a first clad CL1, and the first premolded connector 400A, which is enveloped by the third clad CL3, may be mounted in the first groove H1. At the instant time, in the first premolded connector 400A, power connection portions PC11 and PC12 may protrude to the outside of the first end plate 110A in the second direction, but the exemplary embodiments are not limited thereto.

Thereafter, referring to FIG. 9D, the first clad CL1 is applied to at least a portion of the first core CR1 to cover the first connector 400A. At the instant time, first and second terminal portions T11 and T12 of the first premolded connector 400A may be exposed through the first terminal-mounting hole THHA, the power connection portions PC11 and PC12 of the first premolded connector 400A may protrude to the outside, and the portion of the first premolded connector 400A other than the components T11, T12, PC11, and PC12 may be covered by the first clad CL1, as shown in FIGS. 5 and 9D. In other words, the first clad CL1 may be applied to the metal insert CR1 through double injection molding.

Thereafter, referring to FIG. 9E, a first heater plate 310A is coupled to the first end plate 110A, to which the first clad CL1 has been applied. For example, the first heater plate 310A may be coupled to the first end plate 110A, to which the first clad CL1 has been applied, through laser fusion.

The first heater plate 310A includes an oxygen inlet IN1, a hydrogen inlet IN2, an oxygen outlet OUT1, and a hydrogen outlet OUT2, which communicate with the first end plate 110A, and further includes a first terminal-mounting hole THHA. The first groove H1 is formed in the shape of a blind hole, and the first terminal-mounting hole THHA is formed in the first heater plate 310A in the shape of a through-hole.

Thereafter, referring to FIG. 9F, a first heating element 330A is inserted into and coupled to a first central area CAA of the first heater plate 310A. At the instant time, third and fourth terminal portions T21 and T22 of the first heating element 330A may be coupled to the first and second terminal portions T11 and T12 of the first premolded connector 400A, which are exposed through the first terminal-mounting hole THHA, as shown in FIG. 5.

Thereafter, referring to FIG. 9G, a first current-collecting plate 340A is inserted into the first central area CAA of the first heater plate 310A to be disposed on the first heating element 330A.

Next, a method of manufacturing the second heater assembly 300B will be described below.

FIG. 10A, FIG. 10B, FIG. 10C, FIG. 10D, FIG. 10E, FIG. 10F, FIG. 10G and FIG. 10H are views for explaining a method of manufacturing the second heater assembly 300B of the fuel cell 100.

Referring to FIG. 10A, a second core CR2 having third rigidity, which is a component of a second end plate 110B, which is to be disposed at the other one of the two end portions of the cell stack 122, is prepared. For example, as shown in the drawings, a coolant inlet IN3 and a coolant outlet OUT3 may be formed in the second core CR2. For example, the coolant inlet IN3 and the coolant outlet OUT3 may be formed by manufacturing the second end plate 110B through casting.

Thereafter, as shown in FIG. 10B or 10C, the second core CR2 is machined to form a second groove H2 in the second core CR2. Here, the second groove H2 may have a blind hole shape, as shown in FIG. 8.

Thereafter, as shown in FIG. 10D, a second premolded connector 400B is mounted in the second groove H2. At the instant time, as shown in FIGS. 7B to 7D, the second connector 400B may be enveloped by a fourth clad CL4, which is provided separately from a second clad CL2, and the second premolded connector 400B, which is enveloped by the fourth clad CL4, may be mounted in the second groove H2.

The second groove H2 may be formed to have a shape similar to that of the second premolded connector 400B to receive the second premolded connector 400B therein. For example, when the second premolded connector 400B has the shape shown in FIG. 7C, the second groove H2 may be formed in the shape shown in FIG. 10C, and when the second premolded connector 400B has the shape shown in FIG. 7D, the second groove H2 may be formed in the shape shown in FIG. 10B. Subsequent steps of the manufacturing process will be described with reference to the case in which the second groove H2 is formed in the shape shown in FIG. 10C. However, the following description may also apply to the case in which the second groove H2 is formed in the shape shown in FIG. 10B.

Thereafter, referring to FIG. 10E, the second clad CL2 is applied to at least a portion of the second core CR2 to cover the second premolded connector 400B. In other words, the second clad CL2 may be applied to the metal insert CR2 through double injection molding. At the instant time, first and second terminal portions T31 and T32 of the second premolded connector 400B may be exposed through the second terminal-mounting hole THHB, portions of power connection portions PC21 and PC22 of the second premolded connector 400B may protrude to the outside of the second end plate 110B, and the portion of the second premolded connector 400B other than the components T31, T32, PC21, and PC22 may be covered by the second clad CL2, as shown in FIGS. 8 and 10E.

Thereafter, referring to FIG. 10F, a second heater plate 310B is coupled to the second end plate 110B, to which the second clad CL2 has been applied. For example, the second heater plate 310B may be coupled to the second end plate 110B, to which the second clad CL2 has been applied, through laser fusion.

The second heater plate 310B may include an oxygen inlet IN1, an oxygen outlet OUT1, a coolant inlet IN3, and a coolant outlet OUT3, and may further include a second terminal-mounting hole THHB. The second groove H2 may be formed in the second end plate 110B in the shape of a blind hole, and the second terminal-mounting hole THHB formed in the second heater plate 310B may be formed in the shape of a through-hole.

Thereafter, referring to FIG. 10G, a second heating element 330B is inserted into and coupled to a second central area CAB of the second heater plate 310B. At the instant time, third and fourth terminal portions T41 and T42 of the second heating element 330B may be coupled to the first and second terminal portions T31 and T32 of the second connector 400B, which are exposed through the second terminal-mounting hole THHB, as shown in FIG. 8.

Thereafter, referring to FIG. 10H, a second current-collecting plate 340B is inserted into the second central area CAB of the second heater plate 310B to be disposed on the second heating element 330B.

Hereinafter, the heat generation operation of the first and second heating elements 330A and 330B in the fuel cell according to the exemplary embodiment will be described.

As in the exemplary embodiment described above, when the fuel cell 100 includes one cell stack 122, the first and second connectors 400A and 400B may receive driving signals for driving the first and second heating elements 330A and 330B from a means supplying driving power.

For example, the power connection portions PC11 and PC12 of the first connector 400A may be connected to the driving power supply via external wires OW11 and OW12, the first and second terminal portions T11 and T12 may be connected to the driving power supply via the power connection portions PC11 and PC12 and the first and second internal wires IW11 and IW12, and the third and fourth terminal portions T21 and T22 may receive driving power through the first and second terminal portions T11 and T12, whereby the first heating element 330A may generate heat.

Furthermore, the power connection portions PC21 and PC22 of the second connector 400B may be connected to the driving power supply via external wires OW21 and OW22, the first and second terminal portions T31 and T32 may be connected to the driving power supply via the power connection portions PC21 and PC22 and the first and second internal wires IW21 and IW22, and the third and fourth terminal portions T41 and T42 may receive driving power through the first and second terminal portions T31 and T32, whereby the second heating element 330B may generate heat.

When the above-described fuel cell 100 is mounted to a vehicle, the above-described first and second external wires OW11, OW12, OW21, and OW22 may receive driving power from a junction box (or a high-voltage junction box) of the vehicle, but the exemplary embodiments are not limited thereto. The junction box may be disposed above the stacked cell stack 122. The first and second current-collecting plates 340A and 340B may collect electrical energy generated by the flow of electrons in the cell stack 122 and may transfer the same to the junction box, and the electric power transferred to the junction box may be supplied to a load of the vehicle that utilizes the fuel cell 100.

The junction box is configured to receive and distribute the electric power generated by the fuel cell 100. To the present end, the junction box may be electrically connected to the fuel cell 100 via a terminal block.

Hereinafter, a fuel cell according to a comparative example and the fuel cell according to the exemplary embodiment will be described with reference to the accompanying drawings.

FIG. 11 is an exemplary cross-sectional view of the first or second connector 400A or 400B in the fuel cell 100 according to the exemplary embodiment of the present invention, and FIG. 12 is a cross-sectional view of a first or second connector in a fuel cell according to a comparative example.

Hereinafter, a fuel cell according to a comparative example will be briefly described.

A heater plate and an end plate are provided separately, and are coupled to each other by a snap ring. The heater plate may include first and second heater plates. Here, the first and second heater plates may respectively perform functions corresponding to the functions of the first and second heater plates 310A and 310B according to the exemplary embodiment of the present invention. In the comparative example, the first heater plate may include three bypass plates, and the second heater plate may include two bypass plates. The bypass plates forming each of the first and second heater plates may be manufactured through injection molding, and may be combined with each other through laser fusion to form a single heater plate.

In a process of injection molding the bypass plates, double injection molding is performed such that a first connector of the comparative example, which performs a function corresponding to the function of the first connector of the exemplary embodiment of the present invention, is disposed inside one of the plurality of bypass plates forming the first heater plate and such that a second connector of the comparative example, which performs a function corresponding to the function of the second connector of the exemplary embodiment of the present invention, is disposed inside one of the plurality of bypass plates forming the second heater plate.

The first portion P1 shown in each of FIG. 11 and FIG. 12 corresponds to the first terminal portions T11 and T31 or the second terminal portions T12 and T32 described above, the second portion P2 corresponds to the first internal wires IW11 and IW21 or the second internal wires IW21 and IW22 described above, and the third portion P3 corresponds to the power connection portions PC11 and PC12 (or PC21 and PC22).

The first and second connectors 400A and 400B according to the exemplary embodiment shown in FIG. 11 are accommodated in the first or second core CR1 or CR2 of the first or second end plate 110A or 110B, whereas the first and second connectors shown in FIG. 12 are disposed inside the bypass plates, as described above.

In the case of the comparative example, as shown in FIG. 12, because the first portion P1 and the second portion P2 are formed to be stepped with respect to each other, the thickness of the heater plate accommodating the first and second portions P1 and P2 of the first and second connectors may be greater than when not formed to be stepped as shown in FIG. 11. Further, because the first portion P1 and the second portion P2 are formed to be stepped with respect to each other, the external surface of the heat plate in which the first portion P1 and the second portion P2 are buried may be curved, rather than being flat, and the surface roughness thereof may increase. Furthermore, when the heater plate in which the first and second portions P1 and P2 formed to be stepped with respect to each other are accommodated contracts, the first and second portions P1 and P2 shown in FIG. 12 may project outwards. Accordingly, when the flatness and surface roughness of the heater plate are deteriorated, the external surface of the heater plate is formed to be curved, rather than being flat, making the surface pressure of the cell stack, which is in contact with the heater plate, unstable and deteriorating the airtightness and durability of the fuel cell. The reason for this is that a plurality of unit cells is stacked based on the heater plate. The above problems may become more severe when the second end plate has a coolant inlet IN3 and a coolant outlet OUT3, like the second end plate of the fuel cell according to the embodiment.

In contrast, according to the exemplary embodiment of the present invention, as shown in FIG. 11, because the first portion P1 and the second portion P2 are not formed to be stepped with respect to each other, the first and second portions P1 and P2 may be disposed inside the first or second core CR1 or CR2 even though the thickness of the first or second core CR1 or CR2 is small. Accordingly, when the first portion P1 and the second portion P2 are disposed inside the first and second cores CR1 and CR2, the thicknesses and weights of the first and second heater plates 310A and 310B may be reduced, realizing a lightweight and thin structure. Further, the external surfaces of the first and second heater plates 310A and 310B may become flat, and the surface roughness thereof may be improved. Accordingly, compared to the comparative example, the thickness of the fuel cell 100 in the first direction may be reduced, the flatness and surface roughness of the first and second heater plates 310A and 310B may be improved, and the surface pressure of the cell stack 122 may not be affected. As a result, the fuel cell according to the exemplary embodiment exhibits airtightness and durability superior to the comparative example.

As is apparent from the above description, according to a fuel cell and a method of manufacturing the same according to various exemplary embodiments of the present invention, the fuel cell includes first and second heater plates that are lightweight and thin and have flat external surfaces and improved surface roughness, exhibiting excellent airtightness and durability.

However, the effects achievable through the disclosure are not limited to the above-mentioned effects, and other effects not mentioned herein will be clearly understood by those skilled in the art from the above description.

The above-described various embodiments may be combined with each other without departing from the scope of the present invention unless they are incompatible with each other. Furthermore, for any element or process which is not described in detail in any of the various embodiments, reference may be made to the description of an element or a process having the same reference numeral in another exemplary embodiment of the present invention, unless otherwise specified.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A fuel cell, comprising:
a cell stack including a plurality of unit cells stacked in a predetermined direction.
end plates respectively disposed at first and second end portions of the cell stack, wherein each of the end plates includes a core having first rigidity and a clad covering at least a portion of the core, and wherein the clad has second rigidity lower than the first rigidity;
a heater plate provided with a heating element configured to generate heat in response to a driving power supply, the heater plate being disposed at at least one of positions between the end plates and the first and second end portions of the cell stack; and
a connector accommodated in the core of each of the end plates and covered by the clad, the connector interconnecting the driving power supply and the heating element.

2. The fuel cell of claim 1, wherein the end plates include at least one of:
a first end plate disposed at one of the first and second end portions of the cell stack; or
a second end plate disposed at a remaining one of the first and second end portions of the cell stack,
wherein the core includes at least one of:
a first core of the first end plate; or
a second core of the second end plate,
wherein the clad includes at least one of:
a first clad of the first end plate; or
a second clad of the second end plate,
wherein the heater plate includes at least one of:
a first heater plate disposed between the one of the first and second end portions of the cell stack and the first end plate; or
a second heater plate disposed between the remaining one of the first and second end portions of the cell stack and the second end plate,
wherein the heating element includes at least one of:
a first heating element mounted to the first heater plate; or
a second heating element mounted to the second heater plate, and
wherein the connector includes at least one of:
a first connector accommodated in the first end plate to interconnect the first heating element and the driving power source; or
a second connector accommodated in the second end plate to interconnect the second heating element and the driving power supply.

3. The fuel cell of claim 2,
wherein the first end plate and the first heater plate are modularized, and
wherein the second end plate and the second heater plate are modularized.

4. The fuel cell of claim 2, wherein each of the first heater plate and the second heater plate is composed of one bypass plate.

5. The fuel cell of claim 2, wherein each of the first connector and the second connector includes:
a power connection portion having a positive terminal and a negative terminal connected to the driving power supply;
a first internal wire having one end portion connected to the positive terminal of the power connection portion;
a second internal wire having one end portion connected to the negative terminal of the power connection portion;
a first terminal portion connected to an opposite end portion of the first internal wire; and
a second terminal portion connected to an opposite end portion of the second internal wire.

6. The fuel cell of claim 5, wherein at least one of the first internal wire or the second internal wire is flat without a stepped portion.

7. The fuel cell of claim 5,
wherein the first internal wire and the second internal wire of the first connector are accommodated in the first core and are covered by the first clad, and
wherein the first internal wire and the second internal wire of the second connector are accommodated in the second core and are covered by the second clad.

8. The fuel cell of claim 7,
wherein the first core includes:
a first internal surface facing the one of the first and second end portions of the cell stack in the predetermined direction, the first internal surface having a first groove formed therein to be concavely depressed to allow the first internal wire and the second internal wire to be received therein; and
a first external surface formed opposite to the first internal surface, and
wherein the second core includes:
a second internal surface facing the remaining one of the first and second end portions of the cell stack in the predetermined direction, the second internal surface having a second groove formed therein to be concavely depressed to allow the first internal wire and the second internal wire to be received therein; and
a second external surface formed opposite to the second internal surface.

9. The fuel cell of claim 8,
wherein the first internal wire and the second internal wire of the first connector are enveloped by a third clad and are received in the first groove, and
wherein the first internal wire and the second internal wire of the second connector are enveloped by a fourth clad and are received in the second groove.

10. The fuel cell of claim 9, wherein the third clad includes:
a first fixing portion protruding from a region between the power connection portion and the first terminal portion in a direction intersecting a direction in which the power connection portion and the first terminal portion face each other to fix the first connector to the first core; and
a second fixing portion protruding from a region between the power connection portion and the second terminal portion in a direction intersecting a direction in which the power connection portion and the second terminal portion face each other to fix the first connector to the first core.

11. The fuel cell of claim 10, wherein the first core includes:
a first concave portion receiving the first fixing portion therein; and
a second concave portion receiving the second fixing portion therein.

12. The fuel cell of claim 11, wherein at least one of the first end plate or the second end plate includes:
a hydrogen inlet introducing hydrogen as a reactant gas from an outside into the cell stack;
an oxygen inlet introducing oxygen as a reactant gas from the outside thereof into the cell stack;
a hydrogen outlet discharging hydrogen as a reactant gas and condensate water from the cell stack to the outside;
an oxygen outlet discharging oxygen as a reactant gas and condensate water from the cell stack to the outside;
a coolant inlet introducing a cooling medium from the outside thereof into the cell stack; and
a coolant outlet discharging a cooling medium to the outside.

13. The fuel cell of claim 12,
wherein each of the first concave portion, the second concave portion, the first groove, and the second groove is formed in a region other than regions in which the hydrogen inlet, the oxygen inlet, the hydrogen outlet, the oxygen outlet, the coolant inlet, and the coolant outlet are disposed.

14. The fuel cell of claim 13,
wherein the first end plate includes the hydrogen inlet, the oxygen inlet, the hydrogen outlet, and the oxygen outlet,
wherein the second end plate includes the coolant inlet and the coolant outlet,
wherein the first concave portion, the second concave portion, and the first groove are spaced from the hydrogen inlet, the oxygen inlet, the hydrogen outlet, and the oxygen outlet, and
wherein the second groove is spaced from the coolant inlet and the coolant outlet.

15. The fuel cell of claim 12, wherein the first and second concave portions and the first groove are disposed between the oxygen inlet and the hydrogen outlet.

16. The fuel cell of claim 2,
wherein the first heater plate includes:
a first central area in which the first heating element is disposed; and
a first peripheral area formed adjacent to the first central area,
wherein the second heater plate includes:
a second central area in which the second heating element is disposed; and
a second peripheral area formed adjacent to the second central area, and
wherein at least one of the first peripheral area or the second peripheral area is flat.

17. The fuel cell of claim 2, wherein the core includes a metal material, and the clad includes resin.

18. A method of manufacturing a fuel cell, the method including:
forming a groove in a core of at least one of end plates to be disposed at respective end portions of a cell stack, the core having first rigidity;
mounting a connector in the groove;
applying a clad having second rigidity to at least a portion of the core to cover the connector, the second rigidity being lower than the first rigidity;
coupling a heater plate to each of the end plates to which the clad has been applied; and
inserting a heating element into the heater plate while connecting the heating element to the connector.

19. The method of claim 18, further including:
enveloping the connector using another clad provided separately from the clad,
wherein the connector enveloped by the another clad is mounted in the groove.

20. The method of claim 18, wherein the core includes a metal material, and the clad includes resin.
